(19) United States
(12) Patent Application Publication
(10) Pub. No.: US 2002/0156966 A1
(43) Pub. Date: Oct. 24, 2002

(54) Dual port RAM with automatic write indicators

(76) Inventors: Alan R. Ward, Troy, MI (US); Haitao Lin, Novi, MI (US); Michael R. Lindsay, Commerce Township, MI (US); Michael D. Hesse, Dearborn Hights, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 09/839,275

(22) Filed: Apr. 20, 2001

(51) Int. Cl. G06F 12/00

(52) U.S. Cl. 711/104; 711/131

(57) ABSTRACT

A method is provided for using a dual port RAM to share data between microprocessors at high speed. By using status indicator flags, microprocessors are able to determine whether the data in memory is current and whether or not it had been utilized.

### BACKGROUND OF THE INVENTION

1. Technical Field

The present invention relates generally to a memory circuit for a vehicle communication system. More particularly, the invention relates to a dual port memory architecture which allows for information exchange between two vehicle microprocessors.

2. Background and Summary of the Invention

Most dual port RAM (random access memory) devices simply allow data transfer between two microprocessors. The data is transferred by one microprocessor writing data across a shared parallel data bus that another microprocessor then reads. In effect, the dual port RAM acts as a shared memory array between the two microprocessors. This is sufficient for those applications in which each dual port RAM location is used as a standard RAM location. However, like anything else, this has its limitations. For example, certain applications require the microprocessors to know whether the data stored in a dual port RAM location is current prior to using it. Similarly, a microprocessor which is about to write data to a dual port RAM address needs to know whether the other microprocessor has read the data in the location prior to overwriting and destroying data currently in that location. Naturally, the associated microprocessors could be used to keep track of the interchange of data so that it was known whether the data was current and whether or not it had been read. This too has limitations. The problem with this additional processing is that when large amounts of data are being transferred between the microprocessors, the overhead associated with management of the dual port RAM becomes complex and time consuming. At some point, this renders microprocessor managed dual port RAM unusable in applications where speed is required. One such application which requires speed in order to offer additional features is the sharing of data between a microprocessor used for engine management and a microprocessor used to electronically control an automatic transmission in an automobile.

To thoroughly discuss how the present invention solves the problems described, several definitions are helpful. A “sender” refers to that microprocessor which is writing data into the dual port RAM. A “receiver” is that microprocessor which is reading data out of the dual port RAM that was placed in memory by the sender.

The present invention provides a method of sharing data whereby microprocessor burdens are eliminated and high speed is realized. The invention accomplishes this by using status indicators or flags. This allows a microprocessor which is about to read data out of the dual port RAM to determine whether the data it is about to read is current or not. It also allows a microprocessor which is about to write data to the dual port RAM to determine whether the other microprocessor has read data in the location it is about to write to, thus preventing the overwriting and loss of data.

The method used to determine whether or not the data in the dual port RAM is current includes a write flag associated with each memory location or address in the memory array. More specifically, the preferred embodiment of the present invention includes a dual port RAM that is readable by both sides (sender and receiver), but writable by only one side (the sender). Therefore, two blocks of memory are included in the preferred embodiment dual port Ram. The first is writable only by the first side and readable by both the first and second side. The second is writable only by the second side and readable by both.

Therefore, a write from either side of the dual port RAM works as follows. When a write to an address occurs, a write flag corresponding to that address is placed in an associated register that is visible to both sides. This flag indicates to the receiver side that the data in that address has been updated since the flag was last cleared. The receiver side can then clear this flag by reading the data in that address and clearing the flag in the associated register. Thus, the microprocessor that is reading data knows that the data is current.

Similarly, the sender can use the flag. The sender does this as follows. Prior to writing data to an address, the sender examines the flag. If the flag has not been cleared, the sender knows that the receiver has not read the data and the data could be destroyed by overwriting. However, if the flag has been cleared, the sender knows that the data has been read and that it is safe to re-write new data to that address. Thus, a microprocessor knows whether the other microprocessor has read the data in the location prior to overwriting and destroying data currently in that location. This operation can be very effective when pseudo-data-paging is accomplished through the dual port ram.

The automatic write flag assertion by the dual port ram block state machine unburdens the sending side of the dual port ram from also sending manual semaphores through the ram just to tell the other side that it has written a location as is required in prior systems.

The readability of the write indicator flags by both sides of the dual port ram enable the receiver to know when new data has been written to the ram location since it was last read (the flag is set) and enables the sender to know when the data written to a ram location has been utilized by the receiving side (the flag is clear) so that it can take appropriate actions.

For example, if one microprocessor was to use the dual port ram plus the other microprocessor as an expensive port expansion device, then the sending microprocessor would place data in the dual port ram which it expects the receiving microprocessor to read out and place the value(s) on its port. The receiver would know it has new data in the dual port ram by reading the write flag asserted by the dual port ram state machine. The receiver would then read this data out, place the data on its own port pins, then clear the write flag. This lets the sender know that the data has been put out on the port pins. It, in effect, has confirmation that its actions have taken effect in the other microprocessor.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

Additional objects, advantages, and features of the present invention will become apparent from the following description and appended claims, taken in conjunction with the accompanying drawings in which:

FIG. 1 is a block diagram of the dual port RAM according to the principles of the present invention; and

FIG. 2 is a block diagram of the dual port RAM address space according to the principles of the present invention.

### DETAILED DESCRIPTION OF THE PREFERRED EMBODIMENT

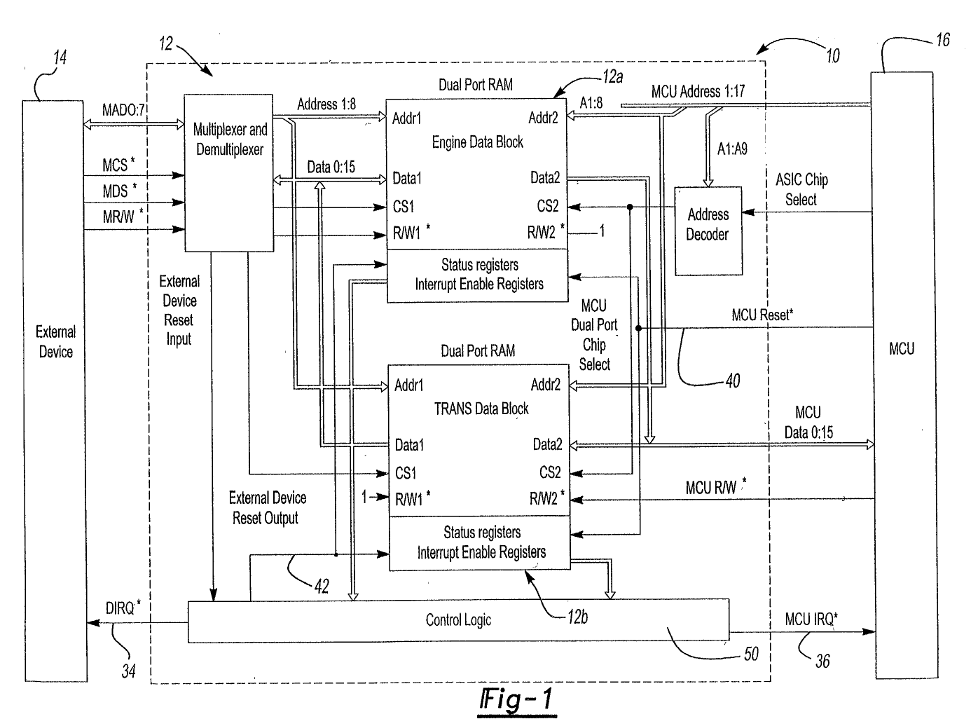

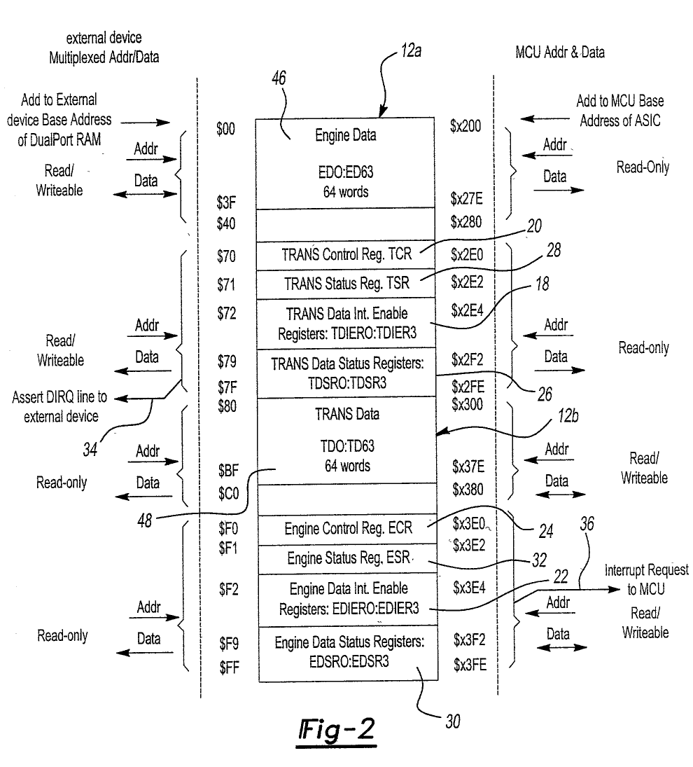

With reference to FIG. 1, the dual port ram structure 10, according to the present invention, will now be described. The dual port ram 10 includes a 128-word array of dual port ram, which is divided into two separate 64-word addressable blocks 12A, 12B. The engine data block 12A is read/writable by an engine control unit 14 and read-only by the transmission control unit 16. The transmission data block 12B is read-only by the engine control unit 14 and read/writable by the transmission control unit 16 as illustrated in FIG. 2. As most clearly seen in FIG. 2, the dual port ram 10 includes control registers of which the engine data block 12A includes transmission data interrupt enable registers 18 (TDIER0:TDIER3) which are read/writable by the engine control unit 14 and read-only by the transmission control unit 16. The engine data block 12A also includes a transmission control register 20 (TCR) which is read/writable by the engine control unit 14 and read-only by the transmission control unit 16. The transmission data block 12B includes engine data interrupt enable registers 22 (EDIER0:EDIER3), which are read-writable by the transmission control unit 16 and read-only by the engine control unit 14. The transmission data block 12B also includes an engine control register 24 (ECR) which is read/writable by the transmission control unit 16 and read-only by the engine control unit 14.

The dual port ram 12 also includes a plurality of status registers. Specifically, the engine data block 12A includes transmission data status registers 26 (TDSR0:TDSR3) which are read/writable by the engine control unit 14 and read-only by the transmission control unit 16. The engine data block 12A also includes a transmission status register 28 (TSR) which is read/writable by the engine control unit 14 and read-only by the transmission control unit 16. The transmission data block includes engine data status registers 30 (EDSR0:EDSR3) which are read/writable by the transmission control unit 16 and read-only by the engine control unit 14. The transmission data block 12B also includes an engine status register 32 (ESR) which is read/writable by the transmission control unit 16 and read-only by the engine control unit 14.

The dual port ram 12 has a capability of generating an interrupt request to the engine control unit 14 and the transmission control unit 16. The device interrupt request line 34 may signal the engine control unit 14 upon one or more writes to the dual port ram 12B from the transmission control unit 16 or when a transmission control unit reset has occurred. The engine control unit interrupt request line 34 may be used by the engine control unit 14 as an interrupt request line or a flag at an input pin. The interrupt request is optional and is controlled by interrupt enable registers 18 (TDIER0:TDIER3).

The dual port ram 12 can also signal the transmission control unit 16 via the transmission control unit interrupt request line 36 upon one or more writes to the dual port ram 12A from the engine control unit 14 or when an engine control unit reset has occurred. The interrupt request is optional, controlled by the interrupt enable registers 22 (EDIER0:EDIER3).

The transmission control unit reset 40 (FIG. 1) will clear the engine data status registers 30 (EDSR0:EDSR3), engine data interrupt enable registers 22 (EDIER0:EDIER3) and engine control register 24 (ECR). In addition, the transmission control unit reset 40 will set the transmission reset bit in the transmission status register 28 (TSR) to inform the engine control unit 14 of the reset from the transmission control unit 16. The transmission reset bit will be held at logic one for the duration of the transmission control unit reset and will stay logic one after transmission reset until cleared by the engine control unit. The engine control unit reset 42 will clear the transmission data status registers 26 (TDSR0:TDSR3), the transmission data interrupt enable register 18 (TDIER0: TDIER3) and the transmission control register 20 (TCR). Furthermore, the engine control unit reset 42 will set the engine control unit reset bit in the engine status register 32 (ESR) to inform the transmission control unit 16 of the reset from the engine control unit 14. The engine control unit reset bit will be held at logic one for the duration of the engine control unit reset and stay logic one after engine reset until cleared by the transmission control unit.

The engine data registers 46 (ED0:ED63) are 64 word-wide RAM registers. These ram registers 46 are read/writable by the engine control unit 14 and read-only by the transmission control unit 16. The engine data registers 46 (ED0:ED63) are full dual port ram with no component level hardware or software arbitration logic required to access these memory locations. The transmission data registers 48 (TD0:TD63) are similarly 64 word-wide ram registers. These ram registers 48 are read/writable by the transmission control unit 16 and read-only by the engine control unit 14. They are full dual port ram with no component level hardware or software arbitration logic required to access these memory locations.

The transmission data status registers 26 (TDSR0:TDSR3) are 4 16-bit transmission data status registers. These registers 26 are readable by the engine control unit 14 and the transmission control unit 16 and only writes of a logic 1 by the engine control unit 14 have an effect on the registers. The bits within the transmission data status registers are set by occurrences of write operations to the transmission data registers 48 (TD0:TD63) respectively from the transmission control unit 16. A logic 1 in each single bit of the transmission data status registers (TDSR0:TDSR3) signals that a write operation to the associated transmission data register 48 has occurred. The bits are defined as (STD0:STD63), which means status of transmission data 0 to 63. (e.g., bit STD5 represents the data status of TD5). Bits STD0:STD63 can only be cleared by writing a 1 to the bit location by the engine control unit 14. Writes of logic 0 by the engine control unit 16 to status bits (STD0:STD63) have no effect. The bits STD0:STD63 in registers 26 (TDSR0:TDSR3), if represented by a 1 indicate a write operation has occurred to the associated transmission data register by the transmission control unit 16 since the status bit was last cleared, and a 0 indicates that no write to the associated transmission data register has occurred since the status bit was last cleared.

The engine data status registers 30 (EDSR0:EDSR3) are 4 16-bit engine data status registers. These registers 30 are readable by engine control unit 14 and transmission control unit 16 and only writes of a logic 1 by the transmission control unit 16 have an effect on the registers. Bits SED0:SED63 in the engine data status registers 30 (EDSR0:EDSR3) are set by occurrences of write operations to the engine data registers (ED0:ED63) respectively from the engine control unit 14. A logic 1 in each single bit of the engine data status registers 30 (EDSR0:EDSR3) signals that a write operation to the associated engine data register 46 has occurred. The bits are defined as SED0:SED63 which means status of ED0 to ED63. (e.g., the bit SED5 represents the data status of ENGINE DATA REGISTER 5 (ED5)). The bits SED0:SED63 can only be cleared by writing a one to the bit location by the transmission control unit 16. Writes of a logic 0 by the transmission control unit 16 to the status bits SED0:SED63 have no effect. The status bits SED0:SED63 in the engine data status registers (EDSR0:EDSR3) is set at 1 if a write operation has occurred to the associated engine data register 46 (ED0:ED63) by the engine control unit 14 since the status bit was last cleared. A zero (0) in status bits SED0:SED63 indicates that no write to the associated engine data register 46 has occurred since the status bit was last cleared.

The transmission status register 28 (TSR) is a 16 bit register containing the status of the transmission control unit 16. The transmission status register 28 is read/writable by the engine control unit 14 and read-only by the transmission control unit 16. The transmission data interrupt enable registers 18 (TDIER0:TDIER3) are 4 16-bit transmission interrupt enable control registers. These registers 18 are readable/writable by the engine control unit 14 and read-only by the transmission control unit 16. The engine data interrupt enable registers 22 (EDIER0:EDIER3) are 4 16 bit engine interrupt enable control registers. These registers 22 are readable/writable by the transmission control unit 16 and read-only by the engine control unit 14. The transmission control register 20 (TCR) is a 16 bit transmission control register. The transmission control register 20 is readable/writable by the engine control unit 14 and read-only by the transmission control unit 16.

The engine status register 32 (ESR) is a 16 bit register containing the status from the engine control unit 14. The engine status register 32 is read/writable by the transmission control unit 16 and read-only by the engine control unit 14.

The engine control register 24 (ECR) is a 16 bit engine control register. The engine control register 24 is readable/writable by the transmission control unit 16 and read-only by the engine control unit 14.

The control logic state machine 50 in the dual port ram 10 looks for write commands from either side of the dual port ram 12A, 12B into the appropriate ram registers. The state machine 50 will then set the appropriate write flag indicator in a status register when a valid write into a dual port ram register occurs. Both controllers 14, 16 have access to the write flag indicators to check whether they are set or clear. A number of protocols could be used between the controllers 14, 16 for setting and clearing the flags. As discussed above, FIG. 2 reveals how the flags are to be visible to both microprocessors 14, 16. There are two sides to the dual port ram 10: the local transmission control unit side and an “engine control unit side”. Each side has its own read/writable space where it places data to be sent and each has its own readable space where each is supposed to read out received data.

The method of providing automatic write indicators is versatile and supports a number of different protocols. For example, for purposes of initialization, the write flag may never be cleared, so in this case the receiver side of a data piece only would use this flag to determine the first time the sending side has sent information. When the write flag is set, the data piece has been initialized.

For purposes of data paging, the write flag of the last set of a string of data pieces may be the only flag monitored and cleared by the microprocessors. The sending side would place data in the ram, meanwhile the receiving side would look for the write flag of the last data piece to get set. When set, the receiving side reads the entire string of data pieces, then clears the write flag indicator of the last data piece only. The sending side sees that the write flag is cleared, so it knows the receiving side has read that information. The sending side can then refill the string of data pieces with a new page of data.

For purposes of “hand shaking” all data sent from the sending side sets the appropriate write flag indicator automatically. The receiving side clears the write flag each time it reads the ram while the flag is set. The sending side then knows the receiving side has processed that data and it can now update the contents of the ram register. The automatic flag indicators allow for a looser tie between the microprocessors and how they handle their dual port ram functions. The automatic write flag indicator setting simplifies software burden of updating new data indicators manually. However, manual write flag clearing is utilized in the present invention because multiple pieces of information may be included in 1 ram data word. To be used as a real ram location, shadowing of the received ram is not efficient. Since multiple data pieces may be handled by different portions of the software, the receiving side would not want to clear the write indicator flag until it has fully processed the incoming data.

The foregoing discussion discloses and describes exemplary embodiments of the present invention. One skilled in the art will readily recognize from such discussion, and from the accompanying drawings and claims, that various changes, modifications, and variations can be made therein without departing from the spirit and scope of the invention as defined in the following claims.

What is claimed is:

1. An indicator mechanism for determining the data written/data read status of data in a dual port RAM, comprising:
a dual port RAM device having data input/output ports; and
a plurality of automatic write indicators used to determine whether data has been written into said dual port RAM device and whether data has been read out of said dual port RAM device.

2. The mechanism of claim 1, wherein said plurality of automatic write indicators are provided within said dual port RAM.

3. The mechanism of claim 1, wherein said indicators are visible to said data input/output ports of said dual port RAM.

4. A method of passing synchronous data between two processors, comprising the steps of:
writing data to a dual port RAM;
providing an automatic write indicator to indicate that data has been written to said dual port RAM;
reading said data from said dual port RAM; and
changing said write indicator to indicate that said data has been read from said dual port RAM.
